(19) United States
(12) Patent Application Publication
(10) Pub. No.: US 2015/0019388 A1
(43) Pub. Date: Jan. 15, 2015

(54) Method and Apparatus for Preventing Fraudulent Transactions Online

(71) Applicant: Kogan Technologies Pty Ltd, South Melbourne (AU)

(72) Inventors: Benjamin Hart, North Melbourne (AU); Ruslan Kogan, Elsternwick (AU); Goran Stefkovski, Hampton (AU); Curtis John Maloney, Oakleigh East (AU); Jesse Xavier O'Connor, Travancore (AU); David Matthew Shafer, Caulfield (AU)

(21) Appl. No.: 13/942,564

(22) Filed: Jul. 15, 2013

(30) Foreign Application Priority Data
Jul. 11, 2013 (AU) 2013206800

(51) Int. Cl. G06Q 20/40; G06Q 30/06

(52) U.S. Cl. CPC G06Q 20/4016; G06Q 30/0635
USPC 705/26.82; 705/26.81

(57) ABSTRACT

A method and apparatus for providing fraud protection in purchase transactions made by a customer. The method including the steps of: receiving a purchase request for one or more items having a first price; generating a second price and/or an applied identifier that is unknown to the customer; applying a charge of the second price and/or the applied identifier using payment details provided; receiving data indicative of a third price and/or a recorded identifier; and comparing the data with the second price and/or the applied identifier; wherein if data is equal to the second price and/or applied identifier then finalise the purchase request.

### FIELD OF THE INVENTION

The present invention relates to protecting against fraud in transactions between a consumer and a business and/or a financial institution, in particular to protecting against fraud in online transactions.

The invention has been developed primarily for use as a method and apparatus that provides protection against fraud in online transactions and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Known methods of fraud protection typically require a manual pre-authentication procedure for a customer, which is conducted either directly through a business that the customer is seeking to engage or through a third party. Methods can include requiring copies of identification documents such as passports or other government issued identity cards.

There is a need in the art for enabling improved fraud protection by ensuring that a customer engaging with a business has access to the credit/debit card statement information linked to payment information used with a business, without necessitating pre-authentication of a customer.

### OBJECT OF THE INVENTION

It is an object of the present invention to overcome or ameliorate at least one of the disadvantages of the prior art, or to provide a useful alternative.

It is an object of the invention in its preferred form to provide a method and/or apparatus that provides protection against fraud in online transactions.

### SUMMARY OF THE INVENTION

According to an aspect of the invention in a preferred form there is provided a method of providing fraud protection in purchase transactions made by a customer. The method including the steps of:
(a) receiving a purchase request for one or more items (or services) having a first price;
(b) calculating a second price by applying a discount (or additional charge) to the first price;
(c) applying a charge of the second price using payment details provided (or on record);
(d) receiving data indicative of a third price; and
(e) comparing the second price and third price; wherein if second price is equal to the third price then finalise the purchase request.

According to an aspect of the invention in a preferred form there is provided a method of providing fraud protection in purchase transactions made by a customer. The method including the steps of:
(a) providing a purchase request for one or more items (or services) having a first price; wherein a substantially random discount (or additional charge) is applied to the first price to calculate a second price, and the second price is charged using payment details provided (or on record); and
(b) providing data indicative of a third price being the amount charged; wherein, if the second price is equal to the third price, finalise the purchase request.

Preferably, the method is provided online. More preferably, the method is provided online through web interface. Most preferably, the method is provided online through web based retail interface.

Preferably, the purchase request includes details of a customer and payment details. More preferably, the first price is the total price for the one or more items in the purchase request.

Preferably, a purchase request is an order request.

Preferably, providing a purchase request includes, selecting one or more items, selecting or providing customer details, selecting or providing billing details, and authorising payment. More preferably, a prospective customer provided the purchase request.

Preferably, applying a charge of the second price using payment details provided is through a third party finance provider. More preferably, the finance provider confirms the charge being applied. Most preferably, comparing the second price and third price only occurs after confirmation of the charge being applied.

Preferably, a substantially random number is calculated or obtained for forming, or to form, a substantially random discount. The substantially random number is preferably sufficiently random, for example a pseudo random number. More preferably the substantially random number is used to calculate a substantially random discount. Most preferably, the discount is in the range of $0.01 to $0.99.

Preferably, after charging the second price, the method further includes the step of: requesting the customer to specify the second price for finalising the purchase request. More preferably, the request can be provided online through a web site or email or other such communications. Alternatively, the request can be provided electronically using SMS or other such communications.

Preferably, the method can further include the step of: upon finalising the purchase request, automatically proceeding to allow dispatch of the one or more items or services. More preferably, an invoice for the first price or second price can be issued after finalising the purchase request. After finalising the purchase request, the random discount can be charged, and then an invoice issued for the first price.

Preferably, the method can further include the step of: upon finalising the purchase request, recording authentication of the customer details and payment details. More preferably, the method can further include the step of: after authenticating customer details and payment details, automatically include the authenticated customer to a white list. Most preferably, the white list further identifies the authenticated payment details and/or customer details. Changing customer details and/or payment details preferably removes the customer from a white list. If a registered customer is on the white list, re-authentication is preferably not required.

Preferably, the method can further include the step of: maintaining a black list of registered customers that have submitted a purchase request but failed authentication and/or registered customers associated with proven fraud attempts. A customer on the black list is preferably unable to submit a purchase request or finalise a purchase request. More preferably, any registered account of a customer on the black list is preferably suspended. A customer is preferably removed from a black list if personally (or separately) authenticated. Most preferably, any customer placed on a black list will be removed from any maintained white list.

According to an aspect of the invention in a preferred form there is provided a method of providing fraud protection in purchase transactions made by a customer. The method including the steps of:
(a) receiving a purchase request for one or more items (or services) having a first price;
(b) generating an applied identifier that is unknown to the customer;
(c) applying a charge of the first price and applied identifier using payment details provided (or on record);
(d) receiving data indicative of a recorded identifier; and
(e) comparing the applied identifier and recorded identifier; wherein if applied identifier is equal to the recorded identifier then finalise the purchase request.

According to an aspect of the invention in a preferred form there is provided a method of providing fraud protection in purchase transactions made by a customer. The method including the steps of:
(a) providing a purchase request for one or more items (or services) having a first price; wherein a substantially random applied identifier is applied to the when the first price is charged using payment details provided (or on record); and
(b) providing data indicative of a recorded identifier; wherein, if applied identifier is equal to the recorded identifier then finalise the purchase request.

Preferably, an applied identifier and a discounted or increase second price can be applied, requiring the customer the provide data indicative of a recorded identifier and/or third price to finalise the purchase request.

According to an aspect of the invention in a preferred form there is provided a method of providing fraud protection in purchase transactions made by a customer. The method including the steps of:
(a) receiving a purchase request for one or more items having a first price;
(b) generating a second price and/or an applied identifier that is unknown to the customer;
(c) applying a charge of the second price and/or the applied identifier using payment details provided;
(d) receiving data indicative of a third price and/or recorded identifier; and
(e) comparing the data with the second price and/or the applied identifier; wherein if data is equal to the second price and/or applied identifier then finalise the purchase request.

According to an aspect of the invention in a preferred form there is provided a method of providing fraud protection in purchase transactions made by a customer. The method including the steps of:
(a) providing a purchase request for one or more items having a first price; wherein a second price and/or applied identifier is applied using payment details provided; and
(b) providing data indicative of a third price and/or a recorded identifier; wherein, if the data is equal to the second price and/or applied identifier then finalise the purchase request.

According to an aspect of the invention in a preferred form there is provided an apparatus for providing fraud protection in purchase transactions. The apparatus including:
a processor element coupleable to a database module, the database module being adapted to retain records of each purchase request;
the processor element being coupleable to a server module for presenting an customer interface to a customer device over a data network and to initiate an purchase request.

Preferably, the customer interface presented by the processor, enables a method as herein disclosed. More preferably, the database module is adapted to retain a record for each registered customer. Most preferably, the database module is adapted to retain a white list and/or a black list as herein described.

Preferably, the processor element communicates with the finance server over the data network to apply (or charge) the second price using provided payment details. More preferably, the finance server confirms the charge being applied over the data network. Most preferably, comparing the second price and third price only occurs after confirmation of the charge being applied.

According to an aspect of the invention in a preferred form there is provided a customer access interface for purchasing one or more items, a processor device being adapted to enable online selection of the items, the processor device being coupleable to database having a record of each purchase request; the interface comprising: a control program adapted to perform a method as herein described.

Preferably, the database module is adapted to retain a record for each registered customer. More preferably, the record of a registered customer includes an associated payment detail. Most preferably, the customer access interface enables registration of a new customer.

According to a further aspect of the invention in a preferred form there is provided a computer program product stored on a computer usable medium, the computer program product adapted to provide a method of fraud protection in online purchase transactions as herein described.

According to a further aspect of the invention in a preferred form there is provided a computer program product stored on a computer usable medium, the computer program product adapted to provide a customer purchase interface for a computer device, the computer device being adapted to receive data indicative of a purchase request, the computer device being coupleable to a database having one or more records indicative of each purchase request; the computer program product comprising: a computer readable program means for enabling or performing each step of a method of fraud protection in online purchase transactions as herein described.

Preferably, fraud protection in online purchase transactions made by a customer places an additional barrier to a customer fraudulently providing a purchase request. More preferably, fraud protection in online purchase transactions made by a customer reduces a seller's (or a retailer's) risk of a fraudulent purchase being approved.

### BRIEF DESCRIPTION OF THE DRAWINGS

A preferred embodiment of the invention will now be described, by way of example only, with reference to the accompanying drawings in which:

FIG. 1 shows a schematic view of an embodiment apparatus according to the invention;

FIG. 2 shows a flowchart of an embodiment method according to the invention;

FIG. 3 shows a flowchart of an embodiment method according to the invention, as undertaken by a customer; and

FIG. 4A-FIG. 4D shows schematic views of an embodiment customer interface according to the invention, as used by a customer.

### PREFERRED EMBODIMENT OF THE INVENTION

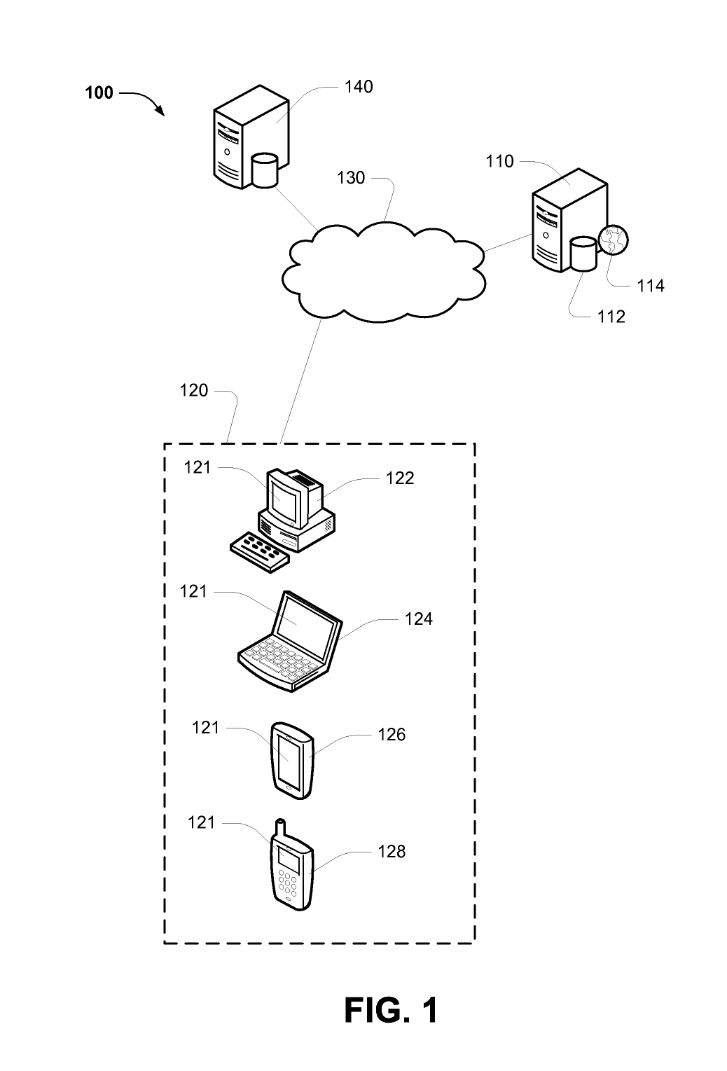

FIG. 1 shows a schematic view of an embodiment apparatus 100 for providing fraud protection in online purchase transactions. The apparatus 100 includes:
a processor element 110 coupleable to a database module 112, the database module being adapted to retain records of each purchase request;
the processor element no being coupleable to a server module 114 for presenting, to a customer device 120 over a data network 130, a customer interface 121 generating and finalising a purchase request.

In this embodiment, by way of example, the customer interface enables a method as herein disclosed. A method can include receiving a purchase request for one or more items (or services) having a first price; calculating a substantially random number for forming, or to form, a substantially random discount; calculating a second price by applying the random discount to the first price; applying a charge of the second price using payment details provided (or on record); receiving data indicative of a third price; and comparing the second price and third price; wherein if second price is equal to the third price then finalise the purchase request. Alternatively, a second price can be provided by applying a discount to the first price that is unknown to the customer; then applying a charge of the second price using payment details provided (or on record). It will be appreciated that the customer interface can be further adapted to provide any other steps used in retail services.

In this embodiment, by way of example, processor element communicates with the finance server 140 over the data network to apply (or charge) the second price using provided payment details. The finance server confirms the charge being applied over the data network. Comparison of the second price and third price only occurs after confirmation of the charge being applied.

In this embodiment, by way of example, the database module is adapted to retain (or maintain) a record for each registered customer and/or to retain (or maintain) a white list and/or to retain (or maintain) a black list. The white list comprising details of customers that have previously successfully authenticated a purchase request using the apparatus—or alternatively been otherwise pre-authenticated. The black list comprising details of customers that have previously unsuccessfully authenticated a purchase request using the apparatus.

It will be appreciated that the customer interfaces are typically presented through a data communication network. For example, an interface is presented through a web interface that is viewable on a: personal computer 122, laptop or netbook 124, tablet device 126 (including personal digital assistant), mobile phone 128 (including: a cell phone or smart phone), or other electronic interface devices. A software application can be provided for facilitating presentation of the respective interface. In an example embodiment, an interface can be tailored for mobile or handheld devices, for example using style sheets. Alternatively, an interface can be a custom interface presented by the respective interface element.

In this embodiment, the processor element can use a web server to present the customer interface via a web interface. It will also be appreciated that software applications can be provided for presenting (or displaying) an interface, whereby the applications can make requests to the processor element via an interface module or alternatively directly access the database.

It will be appreciated that FIG. 1 teaches a client-server environment distributed across a data network, such as the World Wide Web (the Web), in which an online portion of each interface may take place. The architecture of the data network follows a conventional client-server model. The terms “client” and “server” are used to refer to a computer's general role as a requester of data (the client) or provider of data (the server). By way of an example only, a web client 120 and Web server 110 (and web server module 114) communicate using a protocol such as HyperText Transfer Protocol (HTTP). In the Web environment, Web browsers can reside on clients and render Web documents (pages) served by the Web servers. The client-server model is used to communicate information between clients and servers. Web servers are coupled to the data network (for example the Internet) and respond to document requests and/or other queries from Web clients. When a customer selects a document by submitting its Uniform Resource Locator (URL), a Web browser opens a connection to a server and initiates a request (e.g., an HTTP GET) for the document. The server delivers the requested document, typically in the form of a text document coded in a standard mark-up language such as HyperText Markup Language (HTML).

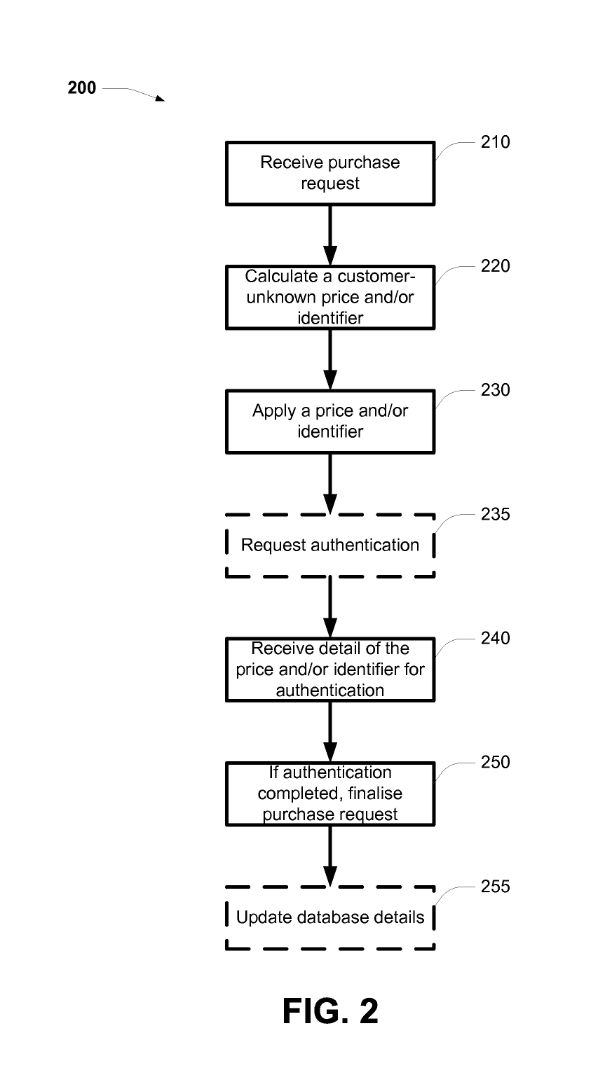

FIG. 2 shows a flowchart of an embodiment method 200 of providing fraud protection in online purchase transactions made by a customer. The method including the steps of:
STEP 210: receiving a purchase request or order request for one or more items having a first price, typically the total price for the one or more items in the purchase request (with or without inclusion of either taxes or postage);
STEP 220: calculating a second price by applying a discount (or additional charge) to the first price;
STEP 230: applying a charge of the second price using payment details provided (or on record);
STEP 240: receiving data indicative of a third price; and
STEP 250: comparing the second price and third price; wherein if second price is equal to the third price then finalise the purchase request.

Optionally, in an embodiment the method STEP 220 can comprise calculating a second price by applying a random discount to the first price, which is unknown to the customer.

Optionally, in an embodiment the method can further include STEP 235, which comprises: after applying the second price, requesting the customer to specify the second price for finalising or authenticating the purchase request. The request can be provided online through a web site or email or SMS or other such communications.

Optionally, in an embodiment the method can further include STEP 255, which comprises: updating database details for the finalised or authenticated purchase request. For example, upon finalising the purchase request, authenticated customer details and payment details can be recorded and automatically included in a “white list”. For example, a “black list” can also be maintained for customers that have submitted a purchase request but failed authentication and/or registered customers associated with proven fraud attempts. Typically, any customer placed on a black list is automatically removed from any maintained white list.

It will be appreciated that a “white list” can include additional data or variables that a business typically retains. For example, additional data may include any one or more of: any customer details which are derived from a certain domain (such as @gov.au) and/or recording credit card partials. Some pre-identified domains (as updated) may be automatically applied to a “white list”, as originating from a trusted domain. Similarly, pre-identified domains (as updated) may be automatically applied to a “black list”, as originating from an non-trusted domain.

In an embodiment, a second price is calculated by applying a discount (or additional charge) to the first price that is initially unknown to the customer. A second price can be calculated by applying a random discount (or random additional charge) to the first price.

In an embodiment, the white list further identifies the authenticated payment details. If a registered customer is on the while list, re-authentication may not be required when using the same details in future purchase requests. Changing customer details or payment details typically removes the customer from a white list.

In some embodiment, a customer on a black list typically will have any account suspended and be unable to submit a further purchase request or finalise a further purchase request. Personal (or separate) authentication is typically required for a customer to be removed from a black list.

It will be appreciated that, by way of example, upon finalising the purchase request, the one or more items can be automatically dispatched, and/or an invoice issued. The invoice can be for the first price or second price. After finalising the purchase request, the random discount can be further charged, and then an invoice issued for the first price. Alternatively, an invoice may be issued after applying a charge to the debit /credit card.

In an embodiment, the purchase request includes customer details (for example, name, address, delivery address), customer payment details (for example credit card details, PayPal details or other payment transfer details), and details of one or more items requested by the customer (typically selected through online shopping).

By way of example, a purchase request by a prospective customer includes: selecting one or more items, selecting or providing customer details, selecting or providing billing details, and authorising payment.

By way or example, applying a charge of the second price using payment details provided can be made through a third party finance provider, that automatically confirms the charge being applied to the nominated account. In this example, comparing the second price and third price occurs after confirmation of the charge being applied.

It will be appreciated that the purchase request and payment authentication can be processed separately from the online retailer. For example, a purchase request may only contain a total purchase price, customer detail and payment details.

In an embodiment, a substantially random number is calculated or obtained for calculating a substantially random discount or additional charge. The discount can, by way of example only, be in the range of: $0.01 to $0.99; or in the range the fractional currency portion of the total price, such that the dollar amount does not change; The substantially random number is preferably sufficiently random, for example a pseudo random number, such that it would be difficult to predict by a customer or customers.

It will be appreciated that, a level of discount (or additional charge) can be applied that suits the businesses objectives of balancing expense and fraud security. It will be further appreciated that the greater the discount (or additional charge) can result in a reduced risk that a fraud customer will be able to randomly guess the correct second price.

In an embodiment, the second price (for example as defined above) is applied using payment details provided (or on record) and then a separate charge of the discount amount is then applied (being the difference between the first price and the second price), such that the third price provided by the customer can be any one or more of: the second price, or the applied discount.

In an alternative embodiment, the second price can be greater than the first price (or invoice price), wherein the third price provided by the customer is indicative of the ‘greater’ second price, such that upon finalising the purchase request by the customer providing a respective third price, the difference between the first price and second price is automatically refunded to the customer.

In an alternative embodiment a second price charged or applied using payment details provided (or on record) is the correct invoice price, but an unknown and/or unique identifier (or code) is provided in the description field of the debit/credit card statement. This identifier is then used to validate the purchase request using the following alternative steps:
STEP 230: applying a charge of the second price (for example equal to the first price) including an applied identifier using payment details provided (or on record);
STEP 240: receiving data indicative of recorded identifier; and
STEP 250: comparing the applied identifier and recorded identifier; wherein if applied identifier is equal to the recorded identifier then finalise the purchase request.

By way of example only, an applied identifier description applied for a $500 purchase would be “KOGAN UD68DS $500.00”, which a customer would then provide or enter UD68DS as a validating identifier. It would be appreciated that the applied identifier would be initially unknown to the customer, and would typically be randomly generated.

It will be appreciated that, if the purchase request is not finalised (for example, within a predefined period), the purchase request can be cancelled and/or the second price automatically refunded.

It will be appreciated that, the method an apparatus can include an online or a telephone purchase request, wherein any one or more of: a discount, an additional charge or identifier—that is initially unknown to customer—is automatically applied using payment details provided (or on record).

In an embodiment, a number of attempts to provide get a correct third/second price or applied/recorded identifier can be predetermined by the business. By way of example only, a business that is more concerned about preventing fraud—than losing a sale—may only allow one or two customer attempts in providing the third/second price or applied/recorded identifier. It will be appreciated that the greater the number of attempts allowed, the higher the likelihood that a fraudster will be able to correctly guess the second price.

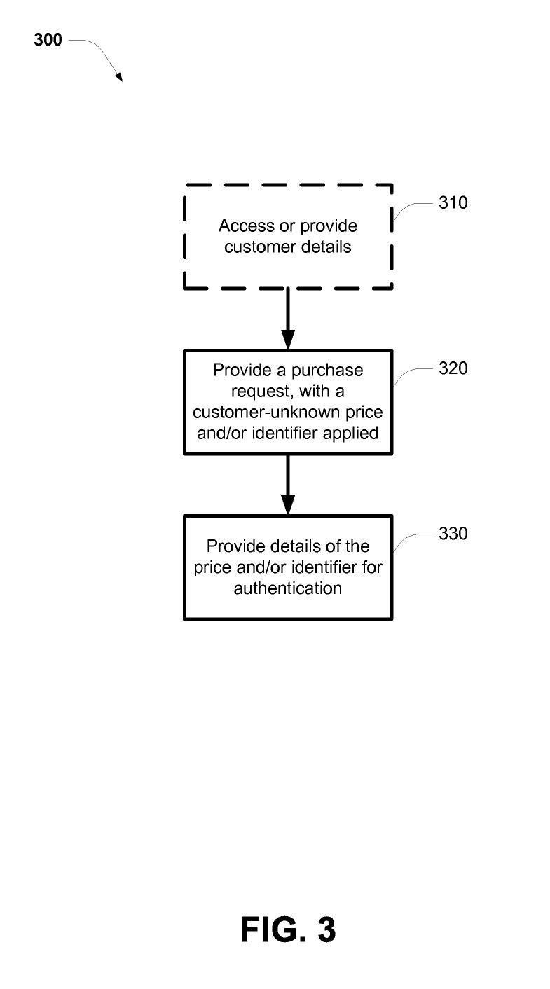

FIG. 3 shows a flowchart of an embodiment method 300 of providing fraud protection in purchase transactions when made by a customer through accessing a customer interface. The method including the steps of:
STEP 320: providing a purchase request for one or more items having a first price; wherein a substantially random discount is applied to the first price to calculate a second price, and the second price is charged using payment details provided (or on record); and
STEP 330: providing data indicative of a third price being the amount charged; wherein, if the second price is equal to the third price, finalise the purchase request.

Optionally, in an embodiment the method STEP 320 can comprise providing a purchase request for one or more items having a first price; wherein a discount is applied to the first price to calculate a second price, which is unknown to the customer, and the second price is charged using payment details provided (or on record).

It will be appreciated that the above methods can be provided online through web interface or web based retail interface.

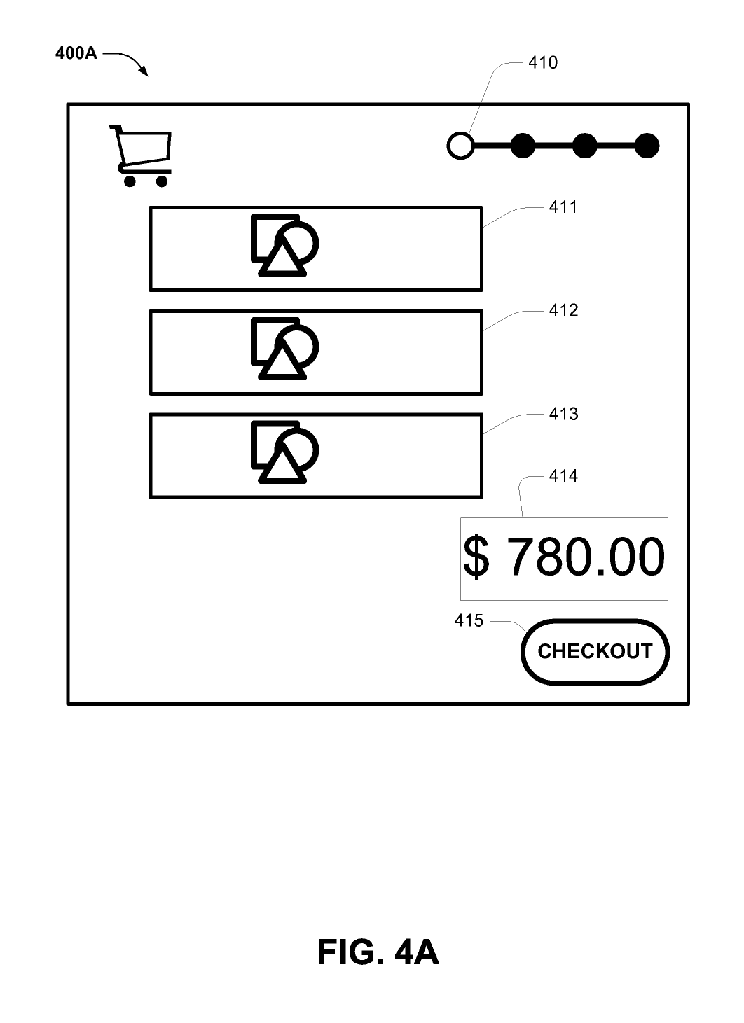

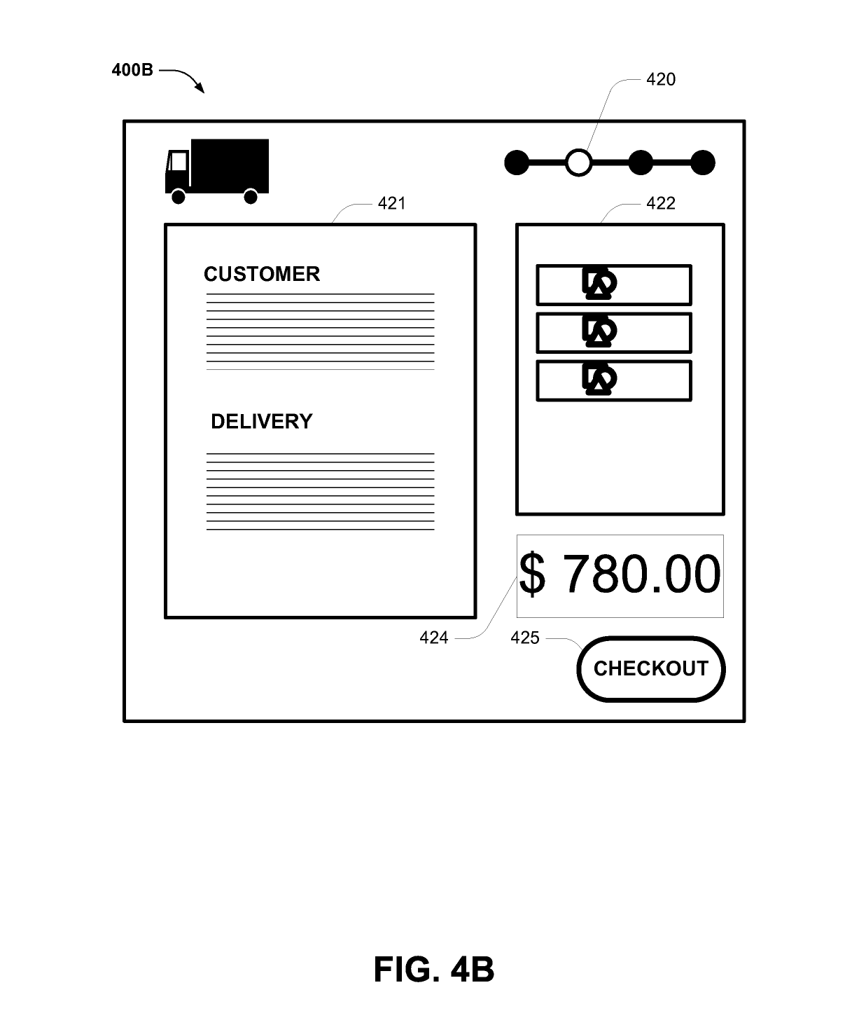

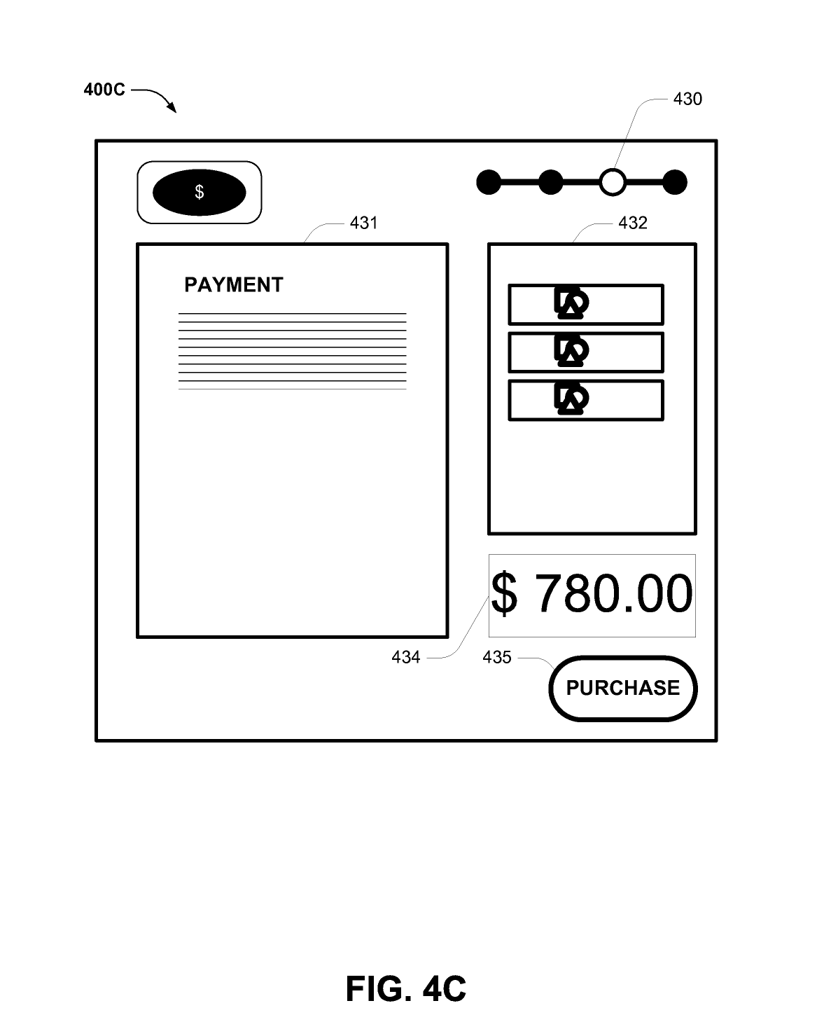

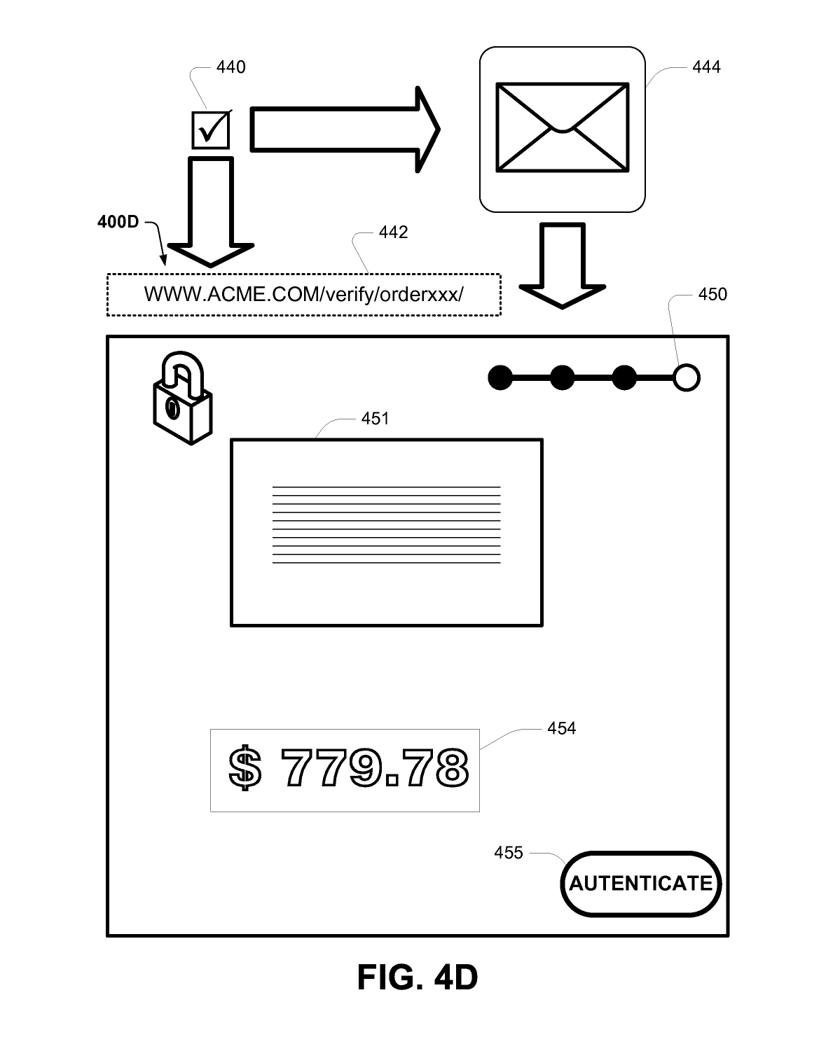

FIG. 4A through FIG. 4D show aspects of an embodiment customer interface, as used by a customer, that provides protection against fraud in online purchases.

FIG. 4A shows an aspect 400A of the customer interface that enables user selection or confirmation of one or more items being purchased or ordered. In this embodiment, by way of example, a purchase progress bar 410 shows this to be a first stage of the purchase procedure. Details of one or more items (411, 412, 413) are displayed for confirmation by the customer. A first price 414 is displayed, being the total of the cost for the one or more items (e.g. a first price). The first price may also include (or be further subject to) taxes and/or delivery fees. A confirmation button 415 enables the customer to proceed to the next stage of a check out process.

FIG. 4B shows a further aspect 400B of the customer interface, which enable customer details to be provided or confirmed. In this embodiment, by way of example, a progress bar 420 shows this to be a second stage of the purchase procedure. A data entry element (or form) 421 enables the customer to provide, select and/or confirm customer details. The customer details can include a customer name and/or customer address details and/or customer contact details and/or customer deliver details. By way of example, a purchase summary 422 can be presented, and a total purchase price (e.g. a first price) 423 displayed. A user input 425 is also provided to proceed to the next stage of the checkout procedure.

FIG. 4C shows a further aspect 400C of the customer interface, which enables payment details to be provided or confirmed. In this embodiment, by way of example, a progress bar 420 shows this to be the third stage of the purchase procedure. A data entry element (or form) 431 enables the customer to provide, select and/or confirm their details. By way of example, a purchase summary 432 can be presented, and a total purchase price (e.g. a first price) 434 displayed. A user input 435 is also provided to proceed to complete the customer purchase request—and proceed to the next stage of the checkout procedure being authentication.

It will be appreciated that an online retailer, upon receiving a purchase request, would typically proceed with using the payment details to charge the full purchase price, through a finance server, and await confirmation of the payment details and charge request being processed or approved. This merely provides some assurance that the payment details were provided correctly, and that the charge can be applied to the finance account indicated by payment details.

FIG. 4D shows a further aspect 400D of the customer interface that enables improved fraud protection in online purchases.

It will be appreciated that, as previously disclosed, upon a purchase request being provided by a customer, the total purchase price (a first price) has a random discount applied (forming a discounted second price) which is not initially disclosed to the customer.

Referring to FIG. 4D, upon receiving confirmation 440 from a finance server that the payment details were approved and the charge (discounted second price) can be applied to a finance facility indicated by the payment details, a further fraud protection process is then commenced. A customer is directed to a further stage 400D of the customer interface. For example, this further stage can be coordinated through the interface server by providing a unique order verification interface or page 400D, which can be identified through a unique identifier (for example: a dynamic URL reference) 442. The customer can be directed to this verification stage of the purchase procedure directly from completing the purchase request and receiving approval of the payment details from the finance server and/or indirectly by providing an email 444 requesting verification (using the customer details provided or confirmed earlier) directed by the unique identifier 442.

By way of example, this verification stage 400D may show a progress bar 450 indicating a final stage of a purchase process. A text element 451 can provide details of the verification procedure, requiring that the customer identify the actual price charged to the finance facility indicated by the payment details provided or selected earlier by the customer. The actual charged price (a second price) or applied identifier is required to be entered to an input 454, wherein upon providing the charged price (third price) or recorded identifier, the customer can select authentication 455 of the purchase process. Upon authentication by the customer, the purchase request can be finalised, and the products delivered.

It will be appreciated that this procedure enables a retailer to confirm that the customer has access to the finance facilities indicated by the payment details provided or previously confirmed, therefore it provides a further or improved means of fraud protection.

It would be appreciated that the customer can then be advised that the purchase order has been authenticated, for example by a web page confirmation or email confirmation.

In an embodiment, a computer program product stored on a computer usable medium can be adapted to provide a method of fraud protection in online purchase transactions as herein described.

In an embodiment, a computer program product stored on a computer usable medium can be adapted to provide a customer purchase interface for a computer device. The computer device being adapted to receive data indicative of a purchase request, the computer device being coupleable to a database having one or more records indicative of each purchase request; the computer program product comprising: a computer readable program means for enabling or performing each step of a method of fraud protection in online purchase transactions as herein described.

It will be appreciated that the disclosed fraud protection in online purchase transactions made by a customer places an additional barrier to a customer fraudulently providing a purchase request, and can thereby reduce a seller's (or a retailer's) risk of a fraudulent purchase being approved.

It will be appreciated that the illustrated embodiments provide improved protection against fraud in online purchases.

Interpretation

It would be appreciated that, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment.

Thus, one embodiment of each of the methods described herein is in the form of a computer-readable carrier medium carrying a set of instructions, e.g., a computer program that are for execution on one or more processors.

Unless specifically stated otherwise, as apparent from the following discussions, it is appreciated that throughout the specification discussions utilizing terms such as “processing”, “computing”, “calculating”, “determining” or the like, can refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken is included.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Similarly, it is to be noticed that the term “coupled”, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment, but may refer to the same embodiment. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Although the invention has been described with reference to specific examples, it will be appreciated by those skilled in the art that the invention may be embodied in many other forms.

It will be appreciated that an embodiment of the invention can consist essentially of features disclosed herein. Alternatively, an embodiment of the invention can consist of features disclosed herein. The invention illustratively disclosed herein suitably may be practiced in the absence of any element which is not specifically disclosed herein.

1. A method of providing fraud protection in purchase transactions made by a customer, the method including the steps of:
(a) receiving a purchase request for one or more items having a first price;
(b) generating a second price and/or an applied identifier that is unknown to the customer;
(c) applying a charge of the second price and/or the applied identifier using payment details provided;
(d) receiving data indicative of a third price and/or a recorded identifier; and
(e) comparing the data with the second price and/or the applied identifier; wherein if data is equal to the second price and/or applied identifier then finalise the purchase request.

2. The method according to claim 1, wherein the second price is generated by applying a discount to the first price; the second price being applied using payment details provided; and upon receiving data indicative of a third price, if the second price is equal to the third price then automatically finalising the purchase request.

3. The method according to claim 2, wherein the applied discount is a random discount that is automatically applied to first price to calculate the second price.

4. The method according to claim 1, wherein the second price is generated by applying an additional charge to the first price; the second price being applied using payment details provided; and upon receiving data indicative of a third price, if the second price is equal to the third price then automatically finalising the purchase request.

5. The method according to claim 4, wherein the applied additional charge is a random additional charge that is automatically applied to first price to calculate the second price.

6. The method according to claim 1, wherein the first price is equal to the second price and the applied identifier is a random character sequence, the data being indicative of a recorded identifier, such that if the data is equal to the applied identifier then the purchase request is automatically finalised.

7. The method according to claim 3, the method further including the step of: requesting the customer to specify the second price and/or the applied identifier for finalising the purchase request.

8. The method according to claim 7, wherein the request is provided online through a web site and/or email.

9. The method according to claim 3, the method further including the step of: upon finalising the purchase request, automatically proceeding to allow dispatch of the one or more items.

10. The method according to claim 9, wherein the method is provided online through web based retail interface for enabling automatic processing of a purchase request.

11. The method according to claim 3, the method further including the step of: after authenticating customer details and payment details, automatically include the authenticated customer to a white list.

12. The method according to claim 11, the method further including the step of: maintaining a black list of registered customers that have submitted a purchase request but failed authentication.

13. The method according to claim 12, the method further including the step of: upon finalising the purchase request, automatically proceeding to allow dispatch of the one or more items.

14. The method according to claim 1, wherein the purchase request includes customer details and payment details.

15. The method according to claim 1, wherein providing a purchase request includes, selecting one or more items, selecting or providing customer details, selecting or providing billing details, and authorising payment.

16. The method according to claim 1, wherein applying a charge of the second price using payment details provided is performed through a third party finance provider, wherein the finance provider confirms the charge being applied, and finalising the purchase request occurs after confirmation of the charge being applied.

17. A method of providing fraud protection in purchase transactions made by a customer, the method including the steps of:
(a) providing a purchase request for one or more items having a first price; wherein a second price and/or applied identifier is applied using payment details provided; and
(b) providing data indicative of a third price and/or a recorded identifier; wherein, if the data is equal to the second price and/or applied identifier then finalise the purchase request.

18. An apparatus for providing fraud protection in purchase transactions, the apparatus including:
a processor element coupleable to a database module, the database module being adapted to retain records of each purchase request;
the processor element being coupleable to a server module for presenting an customer interface to a customer device over a data network and to initiate an purchase request;
wherein the customer interface presented by the processor enables a method according to claim 1.
